(19) United States
(12) Patent Application Publication
(10) Pub. No.: US 2018/0372107 A1
(43) Pub. Date: Dec. 27, 2018

(54) ELECTRIC FAN ASSEMBLY WITH INTEGRATED ROTOR MODULE HAVING QUICK ASSEMBLY FEATURES

(71) Applicant: BorgWarner Inc., Auburn Hills, MI (US)

(72) Inventors: Tobias MOSER, Immenstaad (DE); Frank Michael HAASE, Markdorf (DE)

(21) Appl. No.: 16/015,960

(22) Filed: Jun. 22, 2018

(30) Foreign Application Priority Data
Jun. 23, 2017 (DE) 102017210634.4

(51) Int. Cl. F04D 25/06; F04D 29/32; H02K 1/27; H02K 1/30; H02K 7/14

(52) U.S. Cl. CPC F04D 25/064; F04D 29/329; H02K 1/2786; F04D 25/062; H02K 7/14; F04D 25/0646; H02K 1/30

(57) ABSTRACT

A fan assembly that includes a fan, which has a fan member with a hub and a plurality of fan blades, and an electric motor with a rotor and a stator. The hub is rotatable about an axis and has a front wall and a circumferentially extending wall that cooperate to form a rotor cavity. The rotor has a plurality of first coupling features and a plurality of first snap-fit features formed thereon. The hub has a plurality of second coupling features and a plurality of second snap-fit features formed thereon. The first and second coupling features engage one another to couple the rotor to the hub in a manner that inhibits relative rotation but which permits relative axial movement along the axis. The first and second snap-fit features engage one another to inhibit the rotor from being withdrawn from the rotor cavity.

### CROSS-REFERENCE TO RELATED APPLICATIONS

This application claims the benefit of German Patent Application No. 102017210634.4 filed Jun. 23, 2017, the disclosure of which is herein incorporated by reference in its entirety.

### FIELD

The present disclosure relates to an electric fan with an integrated rotor module having quick assembly features.

### SUMMARY

This section provides a general summary of the disclosure, and is not a comprehensive disclosure of its full scope or all of its features.

In one form, the present disclosure provides a fan assembly that includes a fan and an electric motor. The fan has a fan member with a hub and a plurality of fan blades. The hub is rotatable about a rotational axis and has a front wall and a circumferentially extending wall that cooperate to form a rotor cavity. The electric motor has a rotor and a stator. The rotor has a plurality of first coupling features and a plurality of first snap-fit features formed thereon. The hub has a plurality of second coupling features and a plurality of second snap-fit features formed thereon. The first coupling features and the second coupling features engage one another to couple the rotor to the hub in a manner that inhibits relative rotation but which permits relative axial movement along the rotational axis. The first snap-fit features and the second snap-fit features engage one another to inhibit the rotor from being withdrawn from the rotor cavity.

In a further form, the second snap-fit features include retaining arms having an arm member and an abutment. Each of the arm members has a fixed end, which is fixedly coupled to the hub, and a cantilevered end to which the abutment is mounted. Each of the first snap-fit features comprises an engagement surface against which the abutment is engaged. Optionally, each of the first snap-fit features has a lead surface that is shaped as a part of a frustum, and each of the lead surfaces is configured to deflect the arm members as the rotor is seated into the rotor cavity.

In a further form, the stator comprises a plurality of windings.

In a further form, the rotor includes a rotor member and a mounting structure that is fixedly coupled to the rotor member. The mounting structure defines the first coupling features and the first snap-fit features. Optionally, the rotor member is at least partly encapsulated in the mounting structure. Also optionally the rotor includes a multipole magnet.

In a further form, one of the first coupling features and the second coupling features comprise a plurality of dovetail sockets and the other one of the first coupling features and the second coupling features comprise tails that are configured to be received into the dovetail sockets.

In a further form, the fan comprises an axle that is fixedly coupled to the fan member, the axle having an axle shaft that is rotatably supported by a bearing that is mounted to the stator. Optionally, the axle comprises a head that is encapsulated into the front wall of the hub.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded perspective view of an exemplary electric fan assembly constructed in accordance with the teachings of the present disclosure;

FIG. 2 is a perspective view of a portion of the electric fan assembly of FIG. 1, illustrating a rotor of the electric motor in more detail;

FIG. 3 is a side elevation view of a portion of the rotor;

FIG. 4 is a section view taken along the line 4-4 of FIG. 3;

FIG. 5 is a longitudinal section view of a portion of the electric fan assembly of FIG. 1 that illustrates the rotor of the electric motor secured to a hub of a fan member;

FIG. 6 is a perspective view of a portion of the electric fan assembly of FIG. 1, illustrating the hub of the fan member in more detail; and

FIG. 7 is a longitudinal section view of a portion of the electric fan assembly of FIG. 1.

Corresponding reference numerals indicate corresponding parts throughout the several views of the drawings.

### DETAILED DESCRIPTION

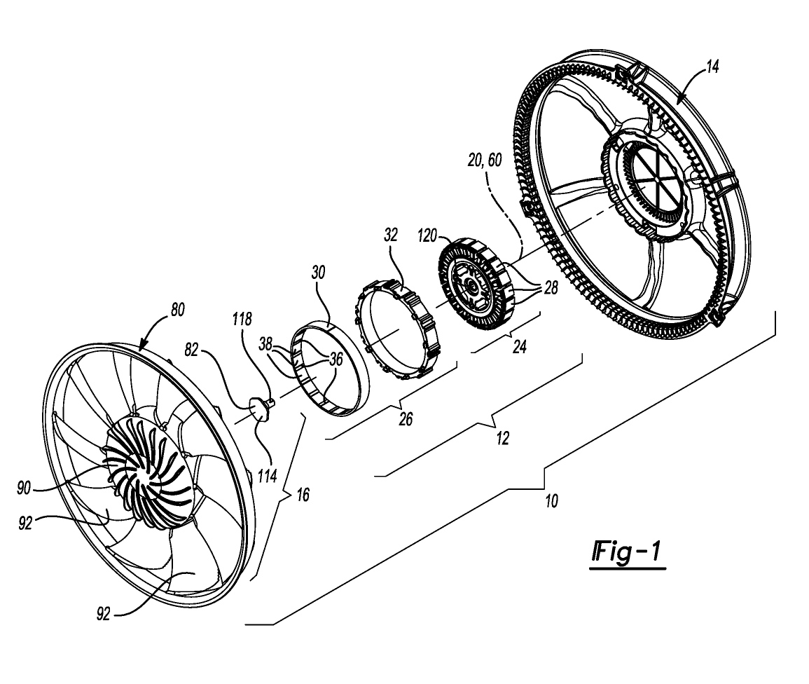

With reference to FIG. 1, an exemplary electric fan assembly constructed in accordance with the teachings of the present disclosure is generally indicated by reference numeral 10. The electric fan assembly 10 can include an electric motor 12, a shroud 14 and a fan 16 that is rotatable relative to the shroud 14 about a rotational axis 20. The electric motor 12 can be any type of electric motor having an “inside-out” configuration with a stator 24 and a rotor 26 that is disposed about (i.e., radially outwardly of) the stator 24. In the particular example provided, the electric motor 12 is a brushless-DC (direct current) electric motor in which the stator 24 is configured with a plurality of windings 28. The stator 24 can be fixedly coupled to any desired structure, such as the shroud 14 and can comprise a plurality of windings 28.

The rotor 26 can comprise a rotor member 30 and a mounting structure 32. The rotor member 30 can be a magnet having a multipole oriented configuration with a plurality of north poles 36 and a plurality of south poles 38 that are juxtaposed with the north poles 36. The mounting structure 32 can be formed of plastic and in the particular example provided, is insert (injection) molded over and onto the rotor member 30 so as to at least partly encapsulate the rotor member 30.

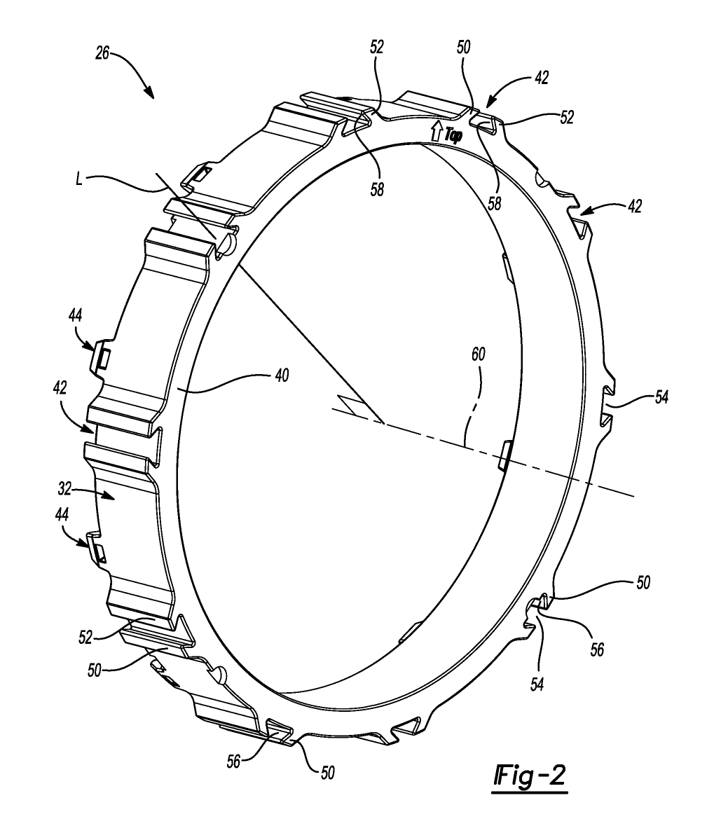

With reference to FIG. 2, the mounting structure 32 can include an annular body 40, a plurality of first coupling features 42 and a plurality of first snap-fit features 44. The first coupling features 42 can be formed on a radially outer side of the annular body 40 and can be disposed circumferentially about the annular body 40 in a desired manner. In the example provided, the first coupling features 42 are disposed symmetrically about the annular body 40 with a common spacing between adjacent ones of the first coupling features 42. Construction in this manner can be advantageous because this configuration is inherently (rotationally) balanced. It should be appreciated, however, that the first coupling features 42 could be spaced about the annular body 40 in a non-symmetrical manner. Non-symmetrical spacing of the first coupling features 42 may be advantageous, for example, to “key” the rotor 26 to the fan 16 so that the rotor 26 can be assembled to the fan 16 in a desired orientation (rotational position).

In the example illustrated, the first coupling features 42 are identical in their configuration (i.e., shape and size), but it will be appreciated that one or more of the first coupling features 42 could be configured differently from other ones of the first coupling features 42. The use of two or more different configurations for the first coupling features 42 can be employed, for example, to “key” the rotor 26 to the fan so that the rotor 26 can be assembled to the fan 16 in a desired orientation (rotational position).

In the particular example provided, the first coupling features 42 comprise dovetail sockets having first and second pins 50 and 52, respectively, that are disposed circumferentially apart from one another to define a groove or socket 54. The first and second pins 50 and 52 can define interior sidewalls 56 and 58, respectively, that can be transverse to a line L that extends from the rotary axis 60 of the rotor 26 through a mid-point of a span between the first and second pins 50 and 52. The interior sidewalls 56 and 58 can be sloped in a manner that would converge to the line L with increasing distance from the rotary axis 60 of the rotor 26. In the example provided, the interior sidewalls 56 and 58 are disposed symmetrically about the line L, but it will be appreciated that the interior sidewalls 56 and 58 could be sized and/or shaped differently.

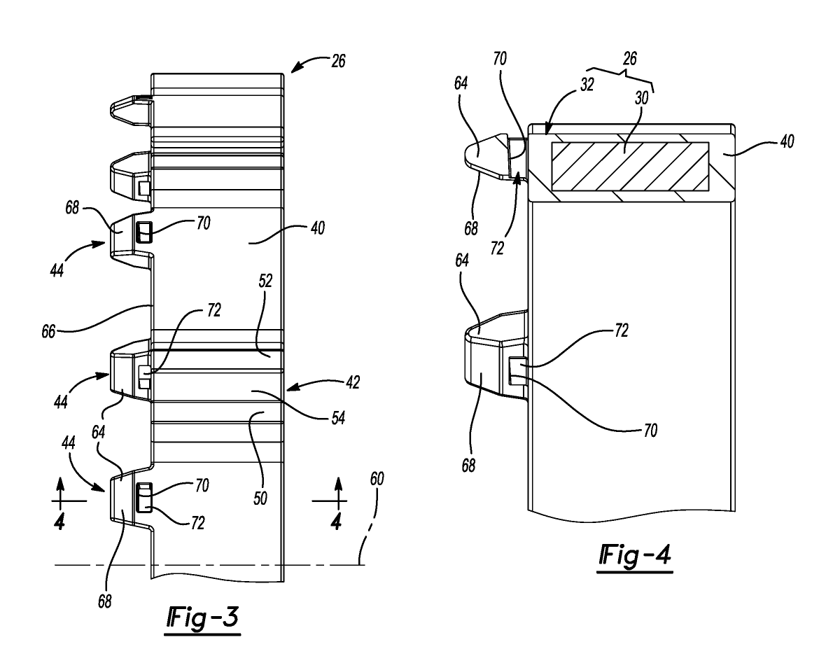

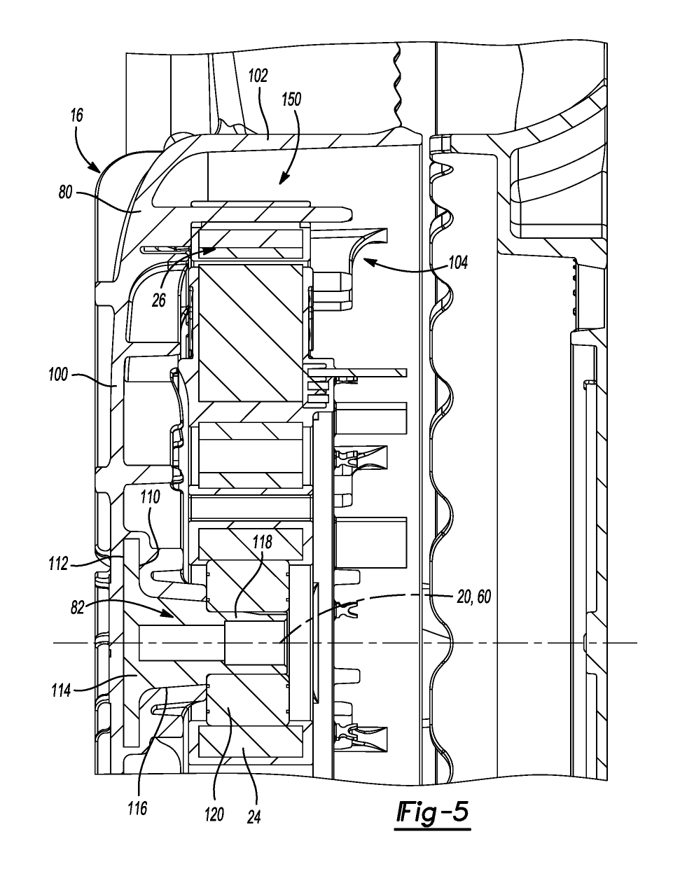

With reference to FIGS. 3 and 4, the first snap-fit features 44 can comprise projections 64 that are disposed circumferentially about the annular body 40 and which extend from an axial end 66 of the annular body 40 that faces toward the fan 16. Each of the projections 64 has a lead surface 68 and an engagement surface 70. Each of the lead surfaces 68 can be formed as a portion of a frustum whose axis is coincident with the rotary axis 60 of the rotor 26. The engagement surfaces 70 in the projections 64 can be formed by a through-hole 72 that is formed radially through each of the projections 64. In the example provided, the through-hole 72 is cast or molded into the mounting structure 32 and as such, the through-hole 72 is tapered on two or more sides to permit a core pin (not shown) in the mold (not shown) to be removed from the mounting structure 32 after the mounting structure 32 has been formed.

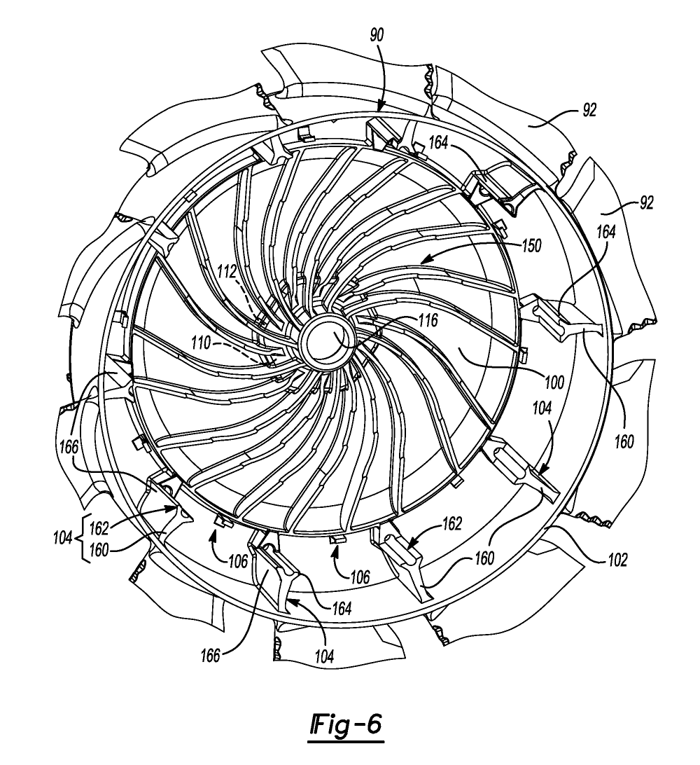

In FIGS. 5 and 6, the fan 16 is an axial flow fan and can comprise a fan member 80 and an axle 82. The fan member 80 can have a hub 90 and a plurality of fan blades 92. The hub can have a front wall 100, a circumferentially extending wall 102, a plurality of second coupling features 104 and a plurality of second snap-fit features 106. The front wall 100 can define an axle socket cavity 110 into which the axle 82 is received. The axle socket cavity 110 can define a recess 112, which is configured to receive a head 114 of the axle 82, and an axle aperture 116 through which an axle shaft 118 of the axle 82 extends. In the example provided, the fan member 80 is molded over and encapsulates the head 114 of the axle 82. The recess 112 and the head 114 cooperate to inhibit rotation of the axle 82 relative to the hub 90 and as such, the recess 112 and the head 114 can be shaped in a non-circular manner, such as hexagonal. It will be appreciated that the head of the axle 82 is encapsulated into the material that forms the fan member 80 in the example provided and that the material that forms the fan member 80 is preferably cohesively bonded to the head 114 of the axle 82. The axle aperture 116 is configured to receive an axle shaft 118 of the axle 82 therethrough. The axle shaft 118 is configured to be received into a bearing 120 that is mounted to the stator 24.

The circumferentially extending wall 102 can be coupled to a radially outer edge of the front wall 100. The circumferentially extending wall 102 and the front wall 100 can cooperate to form a rotor cavity 150 into which the rotor 26 can be received.

With reference to FIGS. 2 and 6, the second coupling features 104 can be coupled to at least one of the circumferentially extending wall 102 and the front wall 100 and can be configured to matingly engage the first coupling features 42 on the rotor 26. In the example provided, the second coupling features comprise tails that are configured to matingly engage the dovetail sockets 54 that are formed on the mounting structure 32 of the rotor 26. Each of the second coupling features 104 can comprise a leg member 160, which can extend radially inwardly into the rotor cavity 150 from the circumferentially extending wall 102, and a tail 162 that can be coupled to a radially inner end of the leg member 160. Each of the tails 162 can comprise exterior sidewalls 164 and 166 that are configured to slidably and matingly engage the interior sidewalls 56 and 58, respectively, of the first coupling features 42. It will be appreciated that receipt of the tails 162 into the sockets 54 can non-rotatably couple the rotor 26 to the hub 90, as well as align the rotary axis 60 of the rotor 26 to the rotational axis 20 of the fan 16 in a coincident manner.

While the first and second coupling features 42 and 104 have been described as comprising dovetail sockets 54 and tails 162, respectively, it will be appreciated that the second coupling features could comprise dovetail sockets and the first coupling features could comprise tails that are configured to be received in and engage the dovetail sockets.

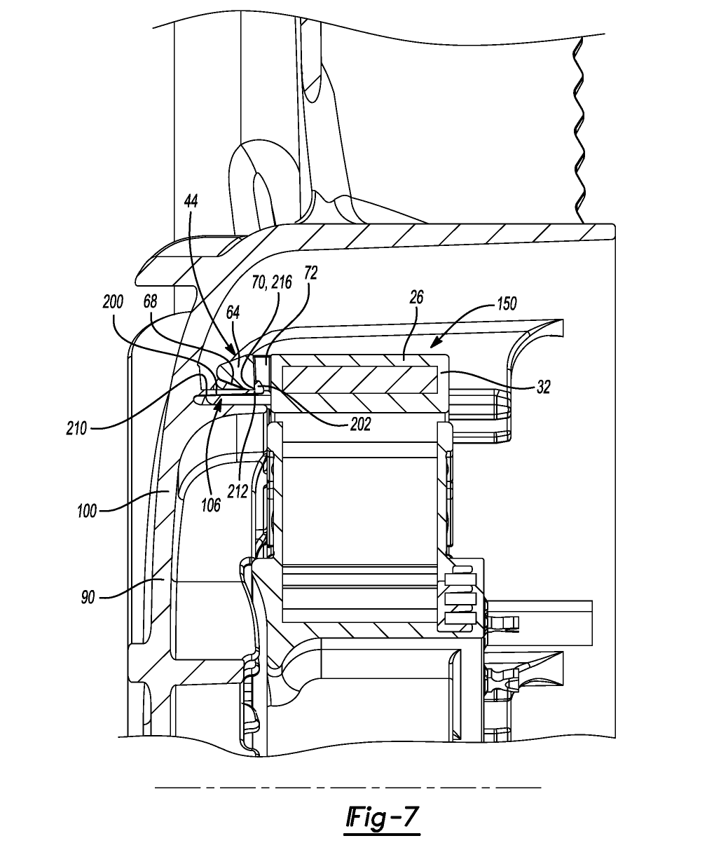

With reference to FIG. 7, the second snap-fit features 106 can be configured to engage the first snap-fit features 44 on the rotor 26 when the first and second coupling features 42 and 104 are engaged to one another and the rotor 26 is seated into the hub 90. The second snap-fit features 106 can comprise retaining arms that can have an arm member 200 and an abutment 202. The arm member 200 can have a fixed end 210, which can be fixedly coupled to a rear side of the front wall 100, and a cantilevered end 212 to which the abutment 202 is mounted. The abutment 202 can be a radially outward projection that can define an abutment surface 216.

The abutment 202 can contact the lead surface 68 on the projections 64 that are formed on the mounting structure 32 as the rotor 26 is moved toward its's fully seated position in the rotor cavity 150. This contact can urge the abutment 202 radially inward and can (resiliently) deflect the cantilevered end 212 of the arm member 200. Alignment of the abutments 202 to the through-holes 72 in the projections 64 permits the arm members 200 to urge the abutments 202 radially outward (into the through-holes 72) so that the abutment surfaces 216 engage the engagement surfaces 70. It will be appreciated that engagement of the abutment surfaces 216 to the engagement surfaces 70 inhibits the withdrawal of the rotor 26 from the rotor cavity 150 along the rotary axis 60 (FIG. 1) of the rotor 26.

While the first snap-fit features 44 have been described as comprising projections 64 and the second snap-fit features 106 have been described as comprising retaining arms (having an arm member 200 and an abutment 202), it will be appreciated that the first snap-fit features 44 could comprise retaining arms and that the second snap-fit features 106 could comprise projections 64.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fan assembly (10) comprising:
a fan (16) having a fan member (80) with a hub (90) and a plurality of fan blades (92), the hub (90) being rotatable about a rotational axis (20) and having a front wall (100) and a circumferentially extending wall (102) that cooperate to form a rotor cavity (150);
an electric motor (12) having a rotor (26) and a stator (24);
characterized in that the rotor (26) has a plurality of first coupling features (42) and a plurality of first snap-fit features (44) formed thereon, the hub (90) has a plurality of second coupling features (104) and a plurality of second snap-fit features (106) formed thereon, the first coupling features (42) and the second coupling features (104) engage one another to couple the rotor (26) to the hub (90) in a manner that inhibits relative rotation but which permits relative axial movement along the rotational axis (20), and the first snap-fit features (44) and the second snap-fit features (106) engage one another to inhibit the rotor (26) from being withdrawn from the rotor cavity (150).

2. The fan assembly (10) of claim 1, characterized in that the second snap-fit features (106) comprise retaining arms having an arm member (200) and an abutment (202), each of the arm members (200) having a fixed end (210), which is fixedly coupled to the hub (90), and a cantilevered end (212) to which the abutment (202) is mounted, and wherein each of the first snap-fit features (44) comprises an engagement surface (70) against which the abutment (202) is engaged.

3. The fan assembly (10) of claim 2, characterized in that each of the first snap-fit features (44) has a lead surface (68) is shaped as a part of a frustum, each of the lead surfaces (68) being configured to deflect the arm members (200) as the rotor (26) is seated into the rotor cavity (150).

4. The fan assembly (10) of claim 1, wherein the stator (24) comprises a plurality of windings (28).

5. The fan assembly (10) of claim 1, characterized in that the rotor (26) includes a rotor member (30) and a mounting structure (32), the mounting structure (32) being fixedly coupled to the rotor member (30) and defining the first coupling features (42) and the first snap-fit features (44).

6. The fan assembly (10) of claim 5, characterized in that the rotor member (30) is at least partly encapsulated in the mounting structure (32).

7. The fan assembly (10) of claim 1, characterized in that the rotor (26) comprises a multipole magnet.

8. The fan assembly (10) of claim 1, characterized in that:
one of the first coupling features (42) and the second coupling features (104) comprise a plurality of dovetail sockets (54); and
the other one of the first coupling features (42) and the second coupling features (104) comprise tails (162) that are configured to be received into the dovetail sockets (54).

9. The fan assembly (10) of claim 1, characterized in that the fan (16) comprises an axle (82) that is fixedly coupled to the fan member (80), the axle (82) having an axle shaft (118) that is rotatably supported by a bearing (120) that is mounted to the stator (24).

10. The fan assembly (10) of claim 9, characterized in that the axle (82) comprises a head (114) that is encapsulated into the front wall (100) of the hub (90).
